(19) United States
(12) Patent Application Publication
(10) Pub. No.: US 2014/0272902 A1
(43) Pub. Date: Sep. 18, 2014

(54) SYSTEM AND METHOD FOR GENERATING AND DISTRIBUTING A SURVEY

(71) Applicant: RESEARCH METRICS, LLC, Toledo, OH (US)

(72) Inventors: Robert A. Bleile, Perrysburg, OH (US); Emil Tsankov, Varna (BG)

(73) Assignee: RESEARCH METRICS, LLC, Toledo, OH (US)

(21) Appl. No.: 13/833,573

(22) Filed: Mar. 15, 2013

(51) Int. Cl. G09B 7/00

(52) U.S. Cl. CPC G09B 7/00
USPC 434/362; 434/322

(57) ABSTRACT

A system and method for generating and distributing a survey includes an executable survey generation application. The survey generation application permits a survey designer to select at least one survey component template associated with a type of survey question from a repository pane of the survey generation application. Selection of the survey component template creates a corresponding survey component within at least one of a working pane and a review pane of the survey generation application. The survey designer may edit the survey component to include desired survey content by entering desired parameters within a data entry pane of the survey generation application. The completed survey may then be distributed to desired recipients by the survey designer activating a publish control of the survey generation application.

### FIELD OF THE INVENTION

The present invention relates to surveys, and more particularly to a system and method for generating and distributing a survey.

### BACKGROUND OF THE INVENTION

Present day survey platforms, especially on mobile devices have very limited ways to present a respondent with a visually attractive and engaging survey. This is largely due to the fact that creating such survey requires time and design skills survey authors usually do not possess. Therefore, the surveys are designed around text of the questions and answers and accompanied with a predefined aesthetic appearance. As such, the respondent experience is dull and not engaging, leading to a high dropout rate and smaller sample sizes. The smaller sample sizes equates to a lower representativeness and a lower accuracy of the results.

Accordingly, it would be desirable to develop a system and method for generating and distributing a survey, which provides a user-friendly environment centered on visual design and functionality of the survey.

### SUMMARY OF THE INVENTION

In concordance and agreement with the present invention, a system and method for generating and distributing a survey, which provides a user-friendly environment centered on a visual design and functionality of the survey, has surprisingly been discovered.

In one embodiment, a survey generation system, comprises: a computing device including a user interface configured to execute a survey generation application, the survey generation application including a control interface, wherein the control interface is configured for creation of a survey, the control interface further comprising: a repository pane configured to display a plurality of survey component templates for selection by a survey designer; a working pane configured to display a corresponding survey component of a selected one of the survey component templates; and a review pane configured to display each of the survey components.

In another embodiment, the present invention is directed to a method of generating a survey.

The method comprises the steps of: executing a survey generation application; selecting at least one survey component template from a repository pane of the survey generation application to create a corresponding survey component within at least one of a working pane and a review pane of the survey generation application; and editing the survey component to include a desired survey content, wherein the editing of the survey component is automatically saved upon completion to militate against a loss thereof.

In yet another embodiment, the present invention is directed to a method for delivering a survey to a respondent.

The method comprises the steps of: generating a customized survey in a compressed downloadable format which minimizes a load and start time of the customized survey by a mobile electronic device.

### DESCRIPTION OF THE DRAWINGS

The above, as well as other advantages of the present invention, will become readily apparent to those skilled in the art from the following detailed description, when considered in the light of the accompanying photographs and illustrations:

FIG. 1 is a block diagram of a survey generation system according to the present invention;

FIG. 2 is a schematic screenshot seen by a survey designer while designing a survey using the survey generation system of FIG. 1 and showing a navigation pane, a review pane, a preview pane, a repository pane, and a data entry pane;

FIG. 3 is an enlarged screenshot of the review pane illustrated in FIG. 2; and

FIG. 4 is an enlarged screenshot of the repository pane illustrated in FIG. 2.

### DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner.

FIG. 1 is a block diagram of a survey generation system 10 according to an embodiment of the invention. The system 10 includes a first computing device 12 provided with a user interface 13, a management server 14, and a second computing device 16 provided with a user interface 17. It is understood that the system 10 may include other additional components as desired. The first computing device 12 includes a memory 22 and a processor 24. The memory 22 may be a single storage device or may be multiple storage devices. Portions of the memory 22 may also be located on the processor 24. Furthermore, the memory 22 may be a solid state storage system, a magnetic storage system, an optical storage system, or any other suitable storage system. In certain embodiments, the memory 22 is configured to store a survey generation program or application 26. Other data may be stored in the memory 22 as described hereinafter.

The processor 24 is configured to retrieve data and/or the survey generation application 26 from the memory 22 of the first computing device 12, as well as execute the survey generation application 26. It is understood that the configuration and functions of the processor 24 may be adjusted in real-time or pre-programmed by the original equipment manufacturer (OEM) or user. It is further understood that the functions of the processor 24 may have stored settings that may be recalled and processed, as desired. The survey generation application 26, which may be embodied within any computer readable medium, includes processor executable instructions for configuring the processor 24 to perform a variety of tasks. Those skilled in the art will appreciate that the survey generation application 26 may be on-line or otherwise accessible to the survey designer over a public or private network such as the Internet 25 or an enterprise network, for example. The survey generation application 26 configures the processor 24 to generate a survey 30 having questions pertaining to interests, motivations, perceptions, preferences, habits, and the like, and requesting inputs in response thereto.

The user interface 13 permits a survey designer using the survey generation application 26 to create and edit a survey 30 in a fast, convenient, and intuitive manner. The survey generation application 26 is configured to both provide information to the survey designer and issue commands to the processor 24. To perform the functions, the survey generation application 26 includes various “tabbed” control interfaces. As illustrated, the control interfaces collectively form the user interface 13 and may include a home interface 42, a clients interface 44, a projects interface 46, an email distribution interface 48, and a reports interface 50 as illustrated in FIG. 2. Additional or fewer control interfaces than shown can be employed in the survey generation application 26 if desired.

The home interface 42 permits the survey designer to review all current surveys 30 in use and provides the survey designer with general information about the current surveys 30 such as a number of responses collected for each of the current surveys 30, for example. Using the clients interface 44, the survey designer can freely navigate between different clients and locate any survey 30 for review and/or editing. For surveys 30 which are already in use, the survey designer must first unpublish the survey 30 before editing. In certain embodiments, the surveys 30 in use can be unpublished by actuating a control (not shown) such as by clicking on a corresponding button, for example. The email distribution interface 48 permits the survey designer to review, select, add, and/or delete distribution information, including but not limited to, an email address of a recipient of the survey 30 such as an interviewer in the field, for example. The survey generation application 26 also permits the survey designer using the reports interface 50 to generate reports related to the surveys 30, including but not limited to, a listing of the surveys 30 for each client, a listing of a number of responses collected for different question-types, a listing of the current surveys 30 in use, etc.

In certain embodiments, the projects interface 46 permits the survey designer to design, preview, publish, and edit any survey 30. As illustrated, the projects interface 46 includes a navigation pane 54, a review pane 56 showing each survey component 58 of the survey 30, a working pane 60 for viewing and/or editing the survey components 58, a repository pane 62 including a plurality of survey component templates 64, and a data entry pane 66 which permits the survey designer to input parameters 68 associated with the selected survey component template 64. It is understood that the projects interface 46 can include other panes as desired.

The navigation pane 54 provides operational controls available to the survey designer. In certain embodiments, the navigation pane 54 includes a back control 70, a publish control 72, a remove survey component control 74, a preview control 76, a computing device selection control 78, a landscape control 80, and a portrait control 82. It is understood that the navigation pane 54 may include additional or fewer operational controls than shown if desired such as an upload control to permit the survey designer to upload content such as digital images, documents, and the like, for example.

The back control 70 permits the survey designer to return to a previous screen within the survey project. Activation of the publish control 72 by the survey designer publishes and distributes the completed survey 30 to the desired recipients (e.g. the interviewers). When it is desired to delete a survey component 58, the survey designer activates the remove survey component control 74 which permits the survey designer to delete any unwanted survey components 58 with a single operation (i.e. one click). The preview control 76 permits the survey designer to view the survey 30 in its entirety while it is being created and in essentially the same manner that the survey 30 will be viewed by a respondent 77 to the survey 30, as well as permits the survey designer to interact with the survey 30 in essentially the same manner that the respondent 77 to the survey 30 will interact with the survey 30 during use. The survey designer, by activating the computing device control 78, is also able to view the survey 30 in essentially the same manner that the survey 30 will appear to the respondent 77 to the survey 30 on different computing devices having various resolutions such as a desktop, a laptop, a mobile or smart phone, a tablet, etc. Additionally, the survey designer can view the survey 30 either in a landscape orientation or a portrait orientation by activating the respective landscape control 80 or the portrait control 82.

FIG. 3 shows the review pane 56 of the projects interface 46 in greater detail. The review pane 56 permits the survey designer to view a thumbnail image of each of the survey components 58 of the survey 30. The survey designer may also select any one of the survey components 58 in the review pane 56 for viewing and editing within the working pane 60. The selected survey component 58 may be accentuated by any means as desired such as surrounding the thumbnail image of the selected survey component with an indicator 83, highlighting the thumbnail image of the selected survey component, increasing a size of the thumbnail image of the selected survey component, or any combination thereof, for example. In certain embodiments, the survey components 58 are arranged sequentially in descending order. For example, a desired first survey component is positioned towards a top of the review pane 56 and a desired last survey component is positioned towards a bottom of the review pane 56. A position of any of the survey components 58 within the survey 30 can be changed by selecting the survey component 58 to be moved, and then moving the selected survey component 58 to a desired position within the survey 30 shown in the review pane 56. It is understood that the survey components 58 within the review pane 56 can be repositioned by any means as desired such as by a “dragging and dropping”, for example. As the survey designer creates the survey 30, the review pane 56 may contain a maximum number of survey components 58 that may be displayed with a viewing area of the review pane 56. In certain embodiments, then, the review pane 56 may be extended by adding a positioning control 84 such as a scroll bar, for example, to selectively control the viewing area of the review pane 56 so that the survey designer may scroll through each of the survey components 58.

With renewed reference to FIG. 2, the working pane 60 provides an accurate view of current settings applied to the selected survey component 58, as well as permits the survey designer to interact with the selected survey component 58 in essentially the same manner that the respondent 77 to the survey 30 will interact with the selected survey component 58 during use. In certain embodiments, the working pane 60 occupies a significant portion of the user interface 13.

Each of the survey components 58 is created by the survey designer using one of the templates 64 from the repository pane 62, shown in greater detail in FIG. 4. The review pane 56 permits the survey designer to view a thumbnail image of each of the templates 64. The templates 64 each represent a generic type or class of survey questions. For example, the template 64 may be identified as a single selection type question requiring only a single input or response from the respondent 77 to the survey 30, a multiple selection type question requiring multiple responses from the respondent 77, or other type question such as a carousel type question, a ranking type question, a slider type question, a keyboard type question, or a location type question, for example. The templates 64 may also represent an introductory survey component (e.g. a start survey component), a conclusory survey component (e.g. a finish survey component or a thank you component), or a section break survey component for separating the survey 30 into defined sections. Each of the templates 64 has a different design (e.g. a two option, a three option, and advanced, etc.) or visual indicia (e.g. emoticons, checkmark, x-mark, etc.). Those skilled in the art will appreciate that the templates 64 can represent virtually any other question type if desired. It is also understood that the repository pane 62 includes blank templates 64 which can be customized and saved by the survey designer for future use. As shown, the templates 64 may be grouped within the repository pane 62 by question type for ease of use and arranged in an accordion-like interface for ease or organization. The most commonly used templates 64 can be copied into a “Favorites” section of the repository pane 62 if desired. In certain embodiments, the repository pane 62 may be extended by adding a positioning control 88 such as a scroll bar, for example, to selectively control the viewing area of the review pane 56 so that the survey designer may scroll through each of the templates 64.

The survey designer may select one of the templates 64 from the repository 62 to create a corresponding editable survey component 58 within the working pane 60. For example, the editable survey component 58 is associated with a single selection, multiple choice type question. As such, the editable survey component 58 may include an editable question field 90 in the data entry pane 66 into which the survey designer may enter a multiple choice question, along with multiple editable answer fields 92 into which the survey designer may enter a desired list of answers to the multiple choice question. In another non-limiting example, the editable survey component 58 represents a single selection, yes/no type question. Here, the editable survey component 58 would include an editable question field 90 in the data entry pane 66 for entering a desired question, and the associated answer fields 92 may be non-editable, and simply contain the two choices “yes” and “no”. The editable survey component 58 may also include an editable requirements field 92 in the data entry pane 66 into which the survey designer may enter whether an answer to the question is required or not. It is understood that the survey designer may select a particular template 64 multiple times, if more than one instance of the corresponding question type is desired in the survey 30.

In certain embodiments, the survey designer may obtain the editable survey component 58 by selecting the desired template 64 in the repository 62 and then “dragging and dropping” the selected template 64 into the review pane 56 at a desired position within the survey 30. In other certain embodiments, the survey designer may drag and drop the selected template 64 into the working pane 60 causing the corresponding survey component 58 to be added to the survey 30 after the survey component 58 currently displayed in the working pane 60. In yet other embodiments, the editable survey component 58 may be obtained by other techniques. For example, the editable survey component 58 may be generated after the currently displayed survey component 58 within the working pane 60, simply by clicking, double-clicking, or otherwise selecting the desired template 64. The present invention also contemplates that all edits, changes, or selections performed with the navigation pane 54, the review pane 56, the working pane 60, the repository pane 62, and the data entry pane 66 are automatically saved immediately upon completion in the memory 22 of the first computing device 12 or the management server 14 of the survey generation system 10, thereby avoiding a loss thereof.

In this way, the survey designer may quickly and easily create the survey 30 with desired survey questions of desired types, obtaining a desired result in a minimal amount of time, while obtaining a highly-customized and useful survey in a convenient and intuitive manner. The survey 30 and images used therein are compressed and saved in a single text document by encoding the images into ASCII text. As such, external references to other files are unnecessary. The entire survey 30 is in a compressed downloadable format which minimizes a load and start time of the survey 30 by the second computing device 16. Accordingly, the survey 30 can be downloaded from the memory 22 of the first computing device 12 or the management server 14 to the second computing device 16 or a web browser in an efficient manner that enhances an experience of the respondent 77 by minimizing a wait time. In certain embodiments, a text format of the survey 30 will be compressed and encoded into 8-bit grayscale PNG image, which is typically less than about one-half of a size of the uncompressed survey 30. Once the survey 30 is downloaded onto the second computing device 16 or the web browser, the survey 30 is decompressed with a canvas object and evaluated as a JavaScript sequence that conventional browsers can execute.

In operation of the survey generation system 10, the survey designer executes the survey generation application 26. The survey designer then selects the projects interface 46 and proceeds to select one of the templates 64 from the repository pane 62. The survey designer may then drag or drop the selected template 64, or otherwise obtain, the corresponding editable survey component 58. The survey designer may then proceed to edit the editable survey component 58. Such editing may include, for example, entering a question and/or answers into the associated fields within the data entry pane 66, or may include arranging or re-arranging the survey components 58 within the review pane 56. If the survey 30 is not complete, then the survey designer may continue adding survey components 58 to the survey 30. As the survey designer creates the survey 30, all edits, changes, or selections performed with the navigation pane 54, the review pane 56, the working pane 60, the repository pane 62, and the data entry pane 66 are automatically saved immediately upon completion in the memory 22 of the first computing device 12. Otherwise, if the survey 30 is complete, then the survey designer may publish and distribute the survey 30 in its entirety to the desired recipients by activating the publish control 72 located within the navigation pane 54.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A survey generation system, comprising:
a computing device including a user interface configured to execute a survey generation application, the survey generation application including a control interface, wherein the control interface is configured for creation of a survey, the control interface further comprising:
a repository pane configured to display a plurality of survey component templates for selection by a survey designer;
a working pane configured to display a corresponding survey component of a selected one of the survey component templates; and
a review pane configured to display each of the survey components.

2. The survey generation system of claim 1, wherein the survey generation application further includes another control interface configured to at least one of permit the survey designer to review surveys in use and provide the survey designer with information about the surveys in use.

3. The survey generation system of claim 1, wherein the survey generation application further includes another control interface configured to permit the survey designer to navigate between different survey clients.

4. The survey generation system of claim 1, wherein the survey generation application further includes another control interface configured to permit the survey designer to at least one of review, select, add, and delete information related to a distribution of the survey.

5. The survey generation system of claim 1, wherein the survey generation application further includes another control interface configured to permit the survey designer to generate reports related to the survey.

6. The survey generation system of claim 1, wherein the survey generation application further includes a navigation pane having at least one operational control for activation by the survey designer.

7. The survey generation system of claim 6, wherein the at least one operational control is at least one of a back control, a publish control, a remove survey component, a preview control, a computing device control, and at least one survey orientation control.

8. The survey generation system of claim 6, wherein the at least one operational control is a preview control configured to permit the survey designer to at least one of view the survey in its entirety while it is being created and in essentially the same manner that the survey will be viewed by a respondent to the survey, and interact with the survey in essentially the same manner that the respondent to the survey will interact with the survey during use.

9. The survey generation system of claim 1, wherein the control interface further includes a data entry pane configured to permit the survey designer to enter parameters associated with the survey component.

10. The survey generation system of claim 1, wherein the survey component templates are grouped by question type within the repository pane.

11. A method of generating a survey, comprising the steps of:
executing a survey generation application;
selecting at least one survey component template from a repository pane of the survey generation application to create a corresponding survey component within at least one of a working pane and a review pane of the survey generation application; and
editing the survey component to include a desired survey content, wherein the editing of the survey component is automatically saved upon completion to militate against a loss thereof.

12. The method of claim 11, wherein the at least one survey component template is one of a single selection type question requiring a single response from a respondent to the survey, a multiple selection type question requiring multiple responses from the respondent, a carousel type question, a ranking type question, a slider type question, a keyboard type question, a location type question, an introductory survey component, a conclusory survey component, and a section break survey component.

13. The method of claim 11, wherein the desired survey content is entered into a data entry pane of the survey generation application.

14. The method of claim 11, wherein the survey component is created by dragging and dropping the selected survey component template into one of the working pane and the review pane of the survey generation application.

15. The method of claim 11, wherein the survey component is created by one of clicking and double-clicking on the selected survey component template.

16. The method of claim 11, wherein the working pane permits a survey designer to interact with the survey component in essentially the same manner that a respondent to the survey will interact with the survey component during use.

17. The method of claim 11, further comprising the step of selecting the survey component displayed in the review pane for at least one of viewing and editing the survey component within the working pane.

18. The method of claim 11, further comprising the step of publishing the survey to at least one desired recipient.

19. A method for delivering a survey to a respondent, comprising the steps of:
generating a customized survey in a compressed downloadable format which minimizes a load and start time of the customized survey by a mobile electronic device.

20. The method of claim 19, wherein the compressed downloadable format is a 8-bit grayscale PNG image.
